(19) United States
(12) Patent Application Publication
(10) Pub. No.: US 2003/0033535 A1
(43) Pub. Date: Feb. 13, 2003

(54) Method and system for implementing a common user logon to multiple applications

(76) Inventors: Gwyn Fisher, Ottawa (CA); Cam Stevenson, Ottawa (CA); Steven Gutz, Ottawa (CA); Doug Hester, Raleigh, NC (US); John Lewis, Raleigh, NC (US)

Correspondence Address: Ralph A. Dowell, Dowell & Dowell, P.C., Suite 309, Jefferson Davis Hwy., Arlington, VA, 22202, US

(21) Appl. No.: 10/205,602

(22) Filed: Jul. 26, 2002

Related U.S. Application Data
(63) Continuation of application No. PCT/CA01/00069, filed on Jan. 29, 2001.
(60) Provisional application No. 60/177,657, filed on Jan. 27, 2000.

(51) Int. Cl. H04K 1/00

(52) U.S. Cl. 713/185

(57) ABSTRACT

A method for implementing a common user logon to one or more applications said method comprising the steps of requesting credentials from said user for authenticating said user and providing a common authentication server for issuing authentication tokens for identifying authenticated users and passing said authentication token to each application that said user requests access for authenticating said user to said accessed application without requesting reentry of credentials from said user.

The invention relates to the field of data processing systems. More specifically, the invention relates to a user logon system incorporating an authentication server.

### BACKGROUND OF THE INVENTION

The continued use of legacy and multi-platform authentication backend systems within the data processing systems of organizations has made granting access to corporate resources an onerous affair. These authentication backend systems may include Windows NT, Windows NT Domains, LDAP (Lightweight Directory Access Protocol), NIS (Network Information System), Active Directory (Windows 2000), NDS (Novel Directory Services), or native UNIX accounts. Typically, each backend authentication system requires its own logon and authenticates to its own directory service. In modern data processing systems, therefore, a user may have to logon several times in order to access the various applications and servers resident on the system. Unless an organization has migrated its accounts and applications to a single authentication backend system or platform, it will face significant problems in efficiency and user training since a customer account or application may exist on or required access to a variety of systems or platforms. For example, if multiple authentication backend systems and user directory services are present, specific code may have to be developed to allow these systems and services to communicate with one another. This may effectively restrict network environments to one particular type of user directory service. The situation is exacerbated in data processing systems that incorporate Internet access and functionality.

Furthermore, the logon requirements of each authentication backend system may vary. For example, in Windows NT, a “USERNAME” and a “DOMAIN” name are used to uniquely identify a user. But, in a particular LDAP directory, just the “UID” attribute (e.g. “ron”) may be used to uniquely identify a user. To accommodate such differences, a data processing system using both NT and LDAP may again require special logic code to facilitate communications between applications and servers.

In addition, if the credentials (e.g. username and password) entered by a user at logon to an initial application or server are to be used by subsequent applications or servers, without a subsequent user logon, then adequate security must be provided for the transfer of these user credentials from the initial to the subsequent applications or servers. If adequate security is not provided, then the advantages of a single logon will be overshadowed by the risk of unauthorized access to data processing system objects. This is especially so in data processing systems that incorporate Internet access and functionality. While prior attempts at solving some of these problems are illustrated in U.S. Pat. Nos. 5,655,077 (Jones, et al.), 5,689,638 (Sadovsky), 6,021,496 (Dutcher, et al.), 6,105,131 (Carroll), and 6,115,040 (Bladow, et al.). None adequately address the resulting security risks identified above.

A need therefore exists to reduce user logon complexity at the desktop while offering an open architecture to integrate easily into current enterprise environments, without changing existing authentication and access control infrastructures. Furthermore, the need exists for a single, secure, unified, common view of the many heterogeneous authentication directories and services that will allow advantage to be taken of each of their unique features while requiring users to logon only once.

### SUMMARY OF THE INVENTION

The invention seeks to provide a method and system for user authentication in a data processing system wherein users only have to logon once, while being able to access multiple applications and servers. The invention addresses the need to reduce user logon complexity at the desktop while offering an open architecture to integrate easily into current enterprise environments, without changing existing authentication and access control infrastructures, thus improving user logon efficiency.

Accordingly, the invention provides a common authentication protocol or proxy (“CAP”) server and a unified application protocol interface (“API”) that allows applications to access existing directory service authentication backends in order to verify users, user groups, and group members.

The invention employs authentication tokens, unified user credentials, and one or more layers of encryption for security. The invention supports many different backend authentication directory services, including, local Windows NT, Windows NT Domains, LDAP (Lightweight Directory Access Protocol), NIS (Network Information System), Active Directory (Windows 2000), NDS (Novell Directory Services), or native UNIX accounts. According to one aspect of the invention, a method for allowing users to access the many applications and servers resident in a data processing system through a single logon is provided. In response to receiving a request for authentication credentials from an application or server that a user wishes to access for the first time in a given session, the application will obtain from the CAP server the type of authentication that is required and will present the user with an appropriate screen asking for the required credentials. Once the application has these credentials it will request the CAP server to authenticate them. If the credentials are valid, then the CAP server will return an authentication token. Now when the application makes a request to one of the other applications or servers resident in the data processing system, it will pass along the authentication token with the request. Prior to performing its operation or function, the subsequent application or server, when it receives the token from the initial application or server, will confirm with the CAP server that the token is valid (i.e. that it came from the CAP server initially) and will receive the user's credentials from the CAP server (i.e. who the user is that the token represents).

To improve security, both the authentication token and the user's credentials are encrypted.

According to another aspect of the invention, a common authentication protocol or proxy (CAP) server system is provided. This CAP server system has stored therein data representing sequences of instructions which when executed cause the above described method and to be performed.

### BRIEF DESCRIPTION OF THE DRAWINGS

The invention may best be understood by referring to the following description and accompanying drawings which illustrate the invention. In the drawings:

FIG. 1 shows a block diagram illustrating an exemplary data processing system including a common authentication protocol or proxy (CAP) server according to one embodiment of the invention;

FIG. 2 shows a block diagram illustrating an exemplary common authentication protocol or proxy (CAP) server according to one embodiment of the invention;

FIG. 3 shows a ladder diagram illustrating the method steps according to one embodiment of the invention.

### DESCRIPTION OF THE PREFERRED EMBODIMENTS

In the following description, numerous specific details are set forth to provide a thorough understanding of the invention. However, it is understood that the invention may be practiced without these specific details. In other instances, well-known software, circuits, structures and techniques have not been described or shown in detail in order not to obscure the invention. The term data processing system is used herein to refer to any machine for processing data, including the computer system(s) and network arrangement(s) described herein. Furthermore, like numerals refer to similar structures in the drawings.

According to one aspect of the invention, a method for allowing users to access the many applications and servers resident in a data processing system through a single logon is described. In response to receiving a request for authentication credentials from an application or server that a user wishes to access for the first time in a given session, the application will obtain from the CAP server the type of authentication that is required and will present the user with an appropriate screen asking for the required credentials. Once the application has these credentials it will request the CAP server to authenticate them. If the credentials are valid, then the CAP server will return an authentication token. Now when the application makes a request to one of the other applications or servers resident in the data processing system, it will pass along the authentication token with the request. Prior to performing its operation or function, the subsequent application or server, when it receives the token from the initial application or server, will confirm with the CAP server that the token is valid (i.e. that it came from the CAP server initially) and will receive the user's credentials from the CAP server (i.e. who the user is that the token represents). To improve security, both the authentication token and the user's credentials are encrypted. As a result of this method, the user need only logon once to obtain access to all applications and servers resident in the data processing system.

According to another aspect of the invention, a common authentication protocol or proxy (CAP) server system is described. This CAP server system has stored therein data representing sequences of instructions which when executed cause the above described method and to be performed. The CAP server system forms part of a data processing system generally having a client application, users, servers, internet access, backend devices, and databases.

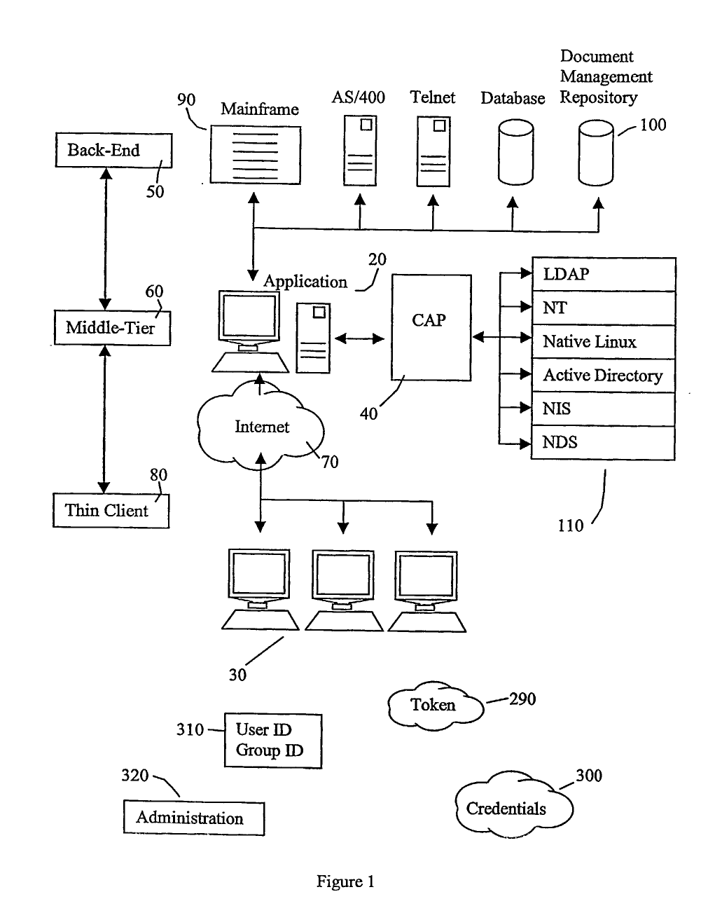

FIG. 1 shows a block diagram illustrating an exemplary data processing system 10 according to one embodiment of the invention. The data processing system 10 includes client applications 20, users 30, a common authentication protocol or proxy (CAP) server 40, the internet 70, and backend devices, databases, and services 50. The client applications 20 may be run on a middle tier processor 60 accessing the internet 70, the users 30 may be employ thin client processors 80, and the backend devices, databases, and services 50 may include mainframe processors 90, document management repositories 100, and directory service authentication backends 110. Of course, the data processing system 10 may contain additional software and hardware a description of which is not necessary for understanding the invention.

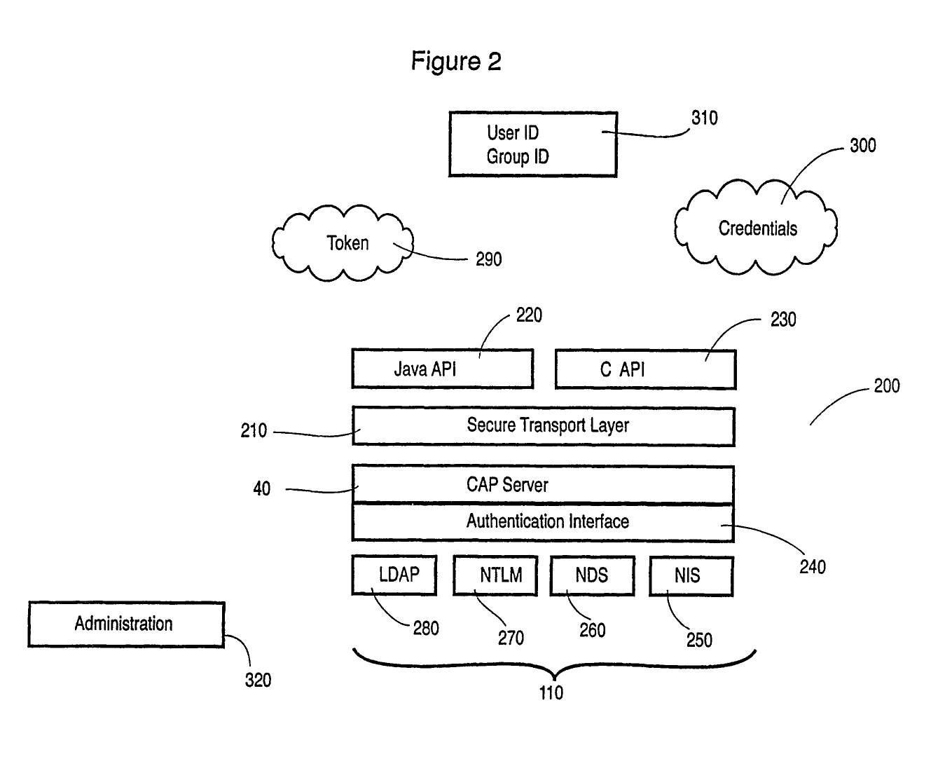

FIG. 2 shows a block diagram illustrating the architecture 200 of an exemplary common authentication protocol or proxy (CAP) server 40 according to one embodiment of the invention. The architecture 200 of the CAP server 40 includes a secure transport layer 210, which communicates with application protocol interfaces (APIs) such as a Java API 220 or a C API 230, and an authentication interface 240 which communicates with directory service authentication backends 110 including NIS 250, NDS 260, NTLM (Windows NT) 270, and LDAP 280. The CAP server 40 may also include administration services 320. While the method and corresponding software instructions described herein may be represented by a series of if/then statements, it is understood that the execution of an instruction does not require a serial processing of these if/then statements. Rather, any mechanism for logically performing this if/then processing is considered to be within the scope of the implementation of the invention. Of course, the common authentication protocol or proxy (CAP) server 40 may contain additional software and hardware a description of which is not necessary for understanding the invention.

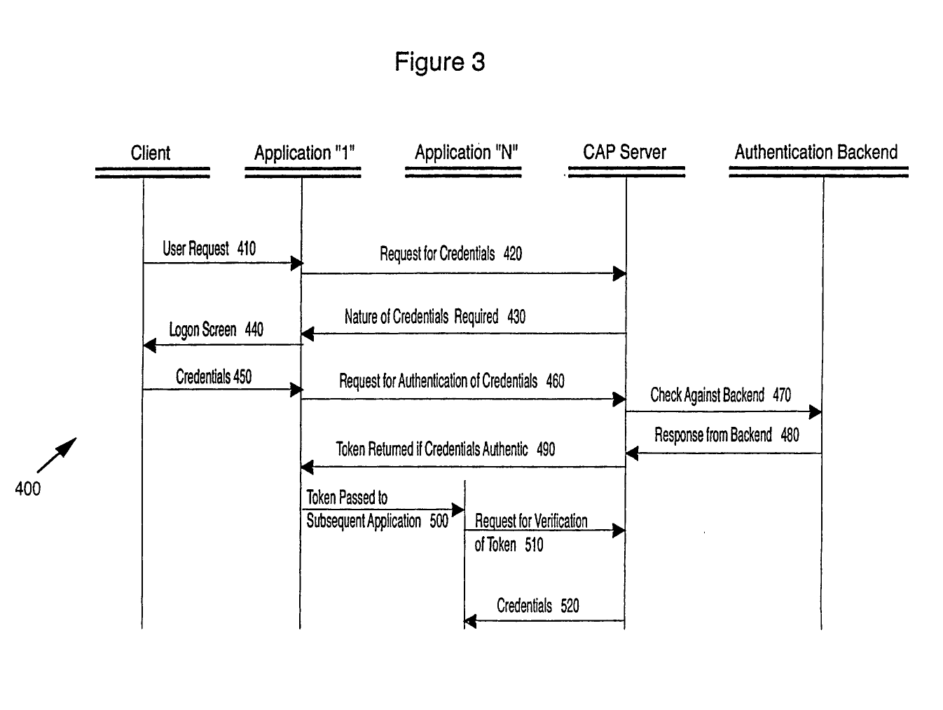

FIG. 3 shows a ladder diagram illustrating the method steps 400 according to one embodiment of the invention.

Referring to FIGS. 1 to 3, the method and system of the invention will now be described. A user 30 wishes to begin an application 20 on the data processing system 10 using a PC or thin client device 80 over a local or remote connection or through the internet 70 (step 410). The application 20 will send a request for authentication credentials 300 to the CAP server 40 (step 420). In response, the CAP server 40 will provide the application 20 with information detailing the nature of the credentials 300 required (step 430). The application 20 will then request that the user logon by entering the required credentials 300 on an appropriate logon screen (step 440). These credentials 300 are the data elements required to uniquely identify and authenticate the user. They may include data elements such as username, domain name, and password. Once the application 20 has the user's credentials 300 (step 450), it will request that the CAP server 40 authenticate them (step 460).

Authentication is the process of identifying a user based on the credentials provided. This process involves comparing the user's credentials to a set of authentic credentials stored in a database. Authentication is distinct from authorization, which is the process of giving a user access to data processing system 10 objects based on their identity. Authentication ensures that the user is who he or she claims to be. Each application 70 may have its own way of authenticating users 30 or user groups, some may even have their own user and/or user group database. Such user databases may be contained in a directory service authentication backend 110. Existing authentication backends 110 include the NIS 250, NDS 260, NTLM 270, and LDAP 280 systems. A data processing system 10 may have several or all of these depending on the requirements of the applications 20 that users 30 wish to run.

The CAP server 40 will perform authentication by accessing the database of the appropriate authentication backend 110 for the given application 20 (step 470). In general, the CAP server 40 is not a user or user group database. Rather, it obtains the user or user group information it requires to perform its authentication function from an external user or user group database contained in an authentication backend 110. Now, a server is a computer that maintains information and applications that may be accessed by a user. And, a proxy server is generally used as a buffer between two networks. For example, a proxy server may be used to prevent unauthorized inbound traffic and restrict downloading by blocking specific sites or types of traffic across a network. Thus, the CAP server 40 acts as a proxy between applications 20 and authentication backends 110.

If the credentials 300 are authentic (step 480), then the CAP server 40 will return an authentication token 290 to the application 20 (step 490). If the credentials 300 are not authentic, then the application 20 will request that the user provide revised credentials 300 or the session will be terminated. Once the application 20 receives the authentication token 290, it begins its session with the user. In other words, the user is authorized to use the application 20.

The authentication token 290 itself is an opaque data element that is passed to any part of the data processing system 10 that needs to know the identity of the user 30. The authentication token 290 indicates that the user supplied authentic credentials 300 to the CAP server 40. The authentication token 290 could be a digital certificate. The authentication token 290 has a user ID (or user group ID) 310 associated with it. The user ID (or user group ID) 310 is composed of the user's credentials 300. The CAP server 40 will provide an application 20 with a user ID (or user group ID) 310, or other credentials 300, only if the corresponding authentication token 290 is valid.

Now, when the application 20 makes a request to one of the other applications 20 resident in the data processing system 10, it will pass along the authentication token 290 with the request (step 500). Prior to performing its operation or function, the subsequent application 20, when it receives the authentication token 290 from the initial application 20, will confirm with the CAP server 40 that the authentication token 290 is valid, that is, that it came from the CAP server 40 initially (step 510). If the authentication token 290 is valid, the CAP server 40 will pass the corresponding user ID (or group ID) 310, or other user credentials 300, to the subsequent application 20 (step 520). As a result, the user 30 need only logon once to obtain access to all applications 20 resident in the data processing system 10.

In general, the CAP server 40 has stored therein data representing sequences of instructions which when executed cause the above described method and to be performed. In particular, the exemplary embodiment of the invention and its CAP server 40 have the unique features and advantages that will be described next.

Referring to FIG. 1 and FIG. 2, the CAP server 40 provides authentication services using a unified application protocol interfaces (“APIs”) 220 or 230 that allows applications 20 to access existing directory service authentication backends 110 in order to verify users, groups and group members. The CAP server 40 supports many different backend authentication directory services 110, including, local Windows NT, Windows NT Domains, LDAP, NIS, Active Directory, NDS or native UNIX accounts. The CAP server 40 is typically an open server. Changes to the source code of existing applications 20 can easily be made to add the APIs 220 or 230 so that the CAP server 40 may be used for authentication, listing users, listing groups and listing group members.

A key advantage of the invention is the client APIs 220 or 230 that encapsulate the communication from the client application 20 to the CAP server 40. The client APIs are provided in both Java 220 and C 230. The Java APIs 220 is provided as a JAR (Java archive) file for both Windows NT and multiple Unix platforms, while the C Language APIs 230 is provided as a DLL (dynamic link library) in NT, and as a shared library in Unix. Since the invention handles user account and password data, two versions of the client APIs 220 or 230 are provided: a version that supports SSL (secure socket layer) for data encryption and one without encryption. The SSL support is included at the transport level within the APIs 220 or 230 such that application developers using the invention do not require any knowledge of SSL or cipher suites. Client applications 20 interface with the CAP server 40 through the top-level Java and C APIs 220 and 230. The CAP server 40 is typically a standalone server that communicates to these APIs 220 and 230 over a secure transport layer 210 (e.g. SSL TCP) connection.

The CAP server 40 incorporates several important security features. Recall that the CAP server 40 is a token-based system that issues authentication tokens 290 back to the client application 20 representing an authenticated user 30. The authentication token 290 is generally stored in cache memory within the data processing system 10 and is passed to each application 20 that the user 30 needs to access without the need to request new credentials 300 each time. Typically, an application 20 is modified to use the invention to authenticate, for example, a internet 70 customer's credentials 300. The credentials 300 (e.g. password and username) are sent by the application 20 over an encrypted (SSL) TCP/IP socket to the CAP server 40, where they are then sent to one of the supported authentication backends 110. Third party applications and products are modified to use the CAP server 40 through client APIs 220 or 230. The CAP server 40 and client APIs 220 or 230 are designed to provide account authentication and user/group services for all application programs 20 that have been appropriately modified. The authentication token 290 that is issued by the CAP server 40 is passed between applications 20, eliminating the need for each application 20 to prompt the user 30 for credentials 300 (e.g. username and password). Now, for added security, the authentication token 290 is encrypted to allow applications 20 to verify that the authentication token 290 originated from the CAP server 40. This encryption mechanism makes it difficult for an unauthorized user to generate a valid authentication token 290. In effect, a double layer of encryption protection is provided.

The exemplary embodiment of the invention also provides for the unified representation of user IDs (or user group IDs) 310. Recall that once an application 20 receives credentials 300 from a user 30, it authenticates these using the CAP server 40. The CAP server 40 authenticates the credentials passed to it against an authentication backend 110 and then generates an authentication token 290 if the credentials 300 are authentic. The invention provides an encryption means to verify that an authentication token 290 originated from the CAP server 40. This verification implies that the user 30 provided valid credentials 300 to the CAP server 40. Once the authentication token 290 is verified the CAP server then returns a user ID (or user group ID) 310, associated with the authentication token 290, to the application 20. Now, since the CAP server 40 acts as an encapsulation layer for different authentication backends 110, the string representation of user IDs (or user group IDs) 310 may be unified. For example, in an NT operating environment (e.g. NTLM 270), the “USERNAME” and “DOMAIN” name are used to uniquely identify a user. However, in a LDAP directory 280, a “UID” attribute like “ron” may be used to uniquely identify a user. The invention allows applications 20 to seamlessly handle this situation using special logic code in the form of the APIs 220 or 230. These are configured such that a unique, single string representation of a user ID (or user group ID) is employed. For example, if the credentials for an NT login has a “USERNAME” given by “ron” and a “DOMAIN” given by “fit”, then the user ID (or user group ID) 310 provided to the application 20, upon verification of the corresponding authentication token 290, would be expressed as “ron@fit”. The CAP server 40 also provides APIs to enumerate such user IDs (or user group IDs) for the authentication backends 110. Such APIs may communicate with the CAP server's 40 authentication interface 240. APIs are also provided to check if a selected user ID (or user group ID), that has been generated for use by the invention, exists in the authentication backends 110.

In the following, the interface 220, 230, and 240 to the CAP server 40 is described in detail. The data structures and function calls are described in IDL (interface definition language) like syntax. This interface itself is implemented in Java and C client APIs 220 and 230 or in authentication interface 240 APIs.

1. Initialization.

Function:

void init (string host, int port);

Description:

Should be called once to initialize the interface so that it will know where the CAP server is located in the data processing system.

2. GetAuthInfo

Function:

sequence<int>getAuthInfo&Ovalhollow;;

Description:

Interrogate the CAP server to find out what the authentication choices are so that the user can be queried for the appropriate credentials.

3. Authenticate

Function:

string authenticate (int type, sequence<string>credentials);

Description:

The type that is passed in will allow the CAP server to know how to interpret the credentials. If you need to pass binary data through one of the credentials then it can be BASE64 encoded. If the credentials are authenticated, then the authentication token will be returned.

4. Validate

Function:

string validate (string ticket);

Description:

Validate an authentication token by checking to see if it came from CAP and then return the user ID (or group ID) that the token represents.

5. IsUserID

Function:

bool isUserID (string userId);

Description:

Determine if a given user ID is a CAP system user. This is used when syncing up with another database.

6. IsMemberOfGroup

Function:

bool isMemberOfGroup (string userId, string groupId);

Description:

Determine if the user ID is a member of the user group ID.

7. Enumeration of Users and Groups

int getUserIDs (string pattern); // users

int getGroupIDs (string pattern); // groups

int getUserIDsForGroupID (string groupId, string pattern); // users in group

int getGroupIDsForUserID (string userId, string pattern); // groups of a user

// Enumeration interface

void skip (int handle, int howMany);

sequence<string>getNext (int handle, int n);

string getNext (int handle);

void release(int handle);

In the following, the configuration of the CAP server 40 is described in detail.

1. Client APIs. The client APIs 220 and 230 are configured based on where the CAP server 40 is located in the data processing system 10. This is accomplished by calling the init&Ovalhollow; function described herein.

2. The CAP Server Itself. The authentication backend 110 which is to be used must be selected

3. LDAP Authentication Backend. The following are configuration items for the LDAP backend 280:

Host

Port

BaseDN (i.e. where to search for users and groups).

Object classes used to define user and group objects.

Attribute used for login (DN, CN, UID, etc.). A search will be performed on the specified attribute. If one entry is found, then the login will be attempted on that entry. If zero entries or more than one entry is found, then it will be an invalid login attempt.

Attribute used for group members.

4. NTLM Authentication Backend. For the NTLM backend 270, the “Default Domain” may be set so that no domain information need be provided at the time of login. In addition, an optional list of NT domains to search for users may be provided.

The CAP server 40 includes an administration system 320 that provides a system administrator with the ability to change or configure the CAP server's 40 properties. Configuration may be HTML (hypertext markup language) based. The HTML pages may be generated by a servlet. The administration screens may be accessible from a browser, an editor, or an enterprise information portal (EIP). The properties that may be changed will vary with the authentication backend 110. The administration system 320 allows the system administrator to remotely configure the CAP server 40. The administration system 320 has the following unique features and advantages:

1. Browser Access. The administration systems 320 is accessible via a browser. This allows it to be a part an enterprise information portal (EIP).

2. Editor Service. The administration system 320 may be part of a separate administration application having its own HTML editor.

3. CAP Server Port. The port where the CAP server 40 is located is configurable.

4. CAP Server Administration Password. The administration system's 320 password is set at the time of installation. The password must be supplied in order to make a change to any of the CAP server's 40 properties.

5. CAP Server Administration Password Configuration. The administration system's 320 password may be changed via the CAP server's 40 administration system's 320 servlet.

6. LDAP Properties. If the CAP server 40 is installed with the LDAP backend 280, then following properties are configurable:

LDAP Server Host

LDAP Server Port

LDAP Authorized DN

LDAP Password

LDAP Search DNs

LDAP User Filter

LDAP Group Filter

LDAP Group Name

LDAP Group Member

7. NTLM Properties. If the CAP server 40 is installed with the NTLM backend 270, then following properties are configurable:

NTLM Domain

8. NIS Properties. If the CAP server 40 is installed with the NIS backend 250, then the following properties are configurable:

NIS Host

NIS Domain

NIS Users

NIS Groups

9. NDS Properties. If the CAP server 40 is installed with the NDS backend 260, then following properties are configurable:

NDS Tree Name

NDS Authorized Name

NDS Authorized Organization

NDS Password

NDS Base

NDS User Filter

NDS User Name

NDS Group Filter

NDS Group Name

NDS Group Member

To expand and reiterate, the exemplary embodiment of the invention has the following unique features and advantages:

1. Client APIs in C and Java. The client APIs are provided in Java 220 and C 230. These client APIs “wrap up” communications to the CAP server 40. They may also perform certain optimizations on the client side of the application 20 where appropriate. On the NT platform, the C API 230 may be in the form of a DLL. On the Unix platform, the C API 230 is in the form of a shared library. The Java API 220 is provided in a JAR file for all platforms.

2. Internationalization Support. The CAP server 40 and the client APIs 220 and 230 support international character sets using the UTF-8 form of Unicode. In addition, a simple ANSI version of the C API 230 is provided.

3. Support for NT and Unix Platforms. The CAP server 40 may be implemented to run on NT and Unix (Solaris, Linux, and AIX) platforms. Note that in general, not all authentication backends 110 will be available on all server platforms. For example, the NTLM backend 270 may not be available when the CAP server 40 is installed on a Unix platform. The client APIs 220 and 230 may also run on NT and Unix platforms.

4. Peering Servers. Multiple instances of the CAP server 40 are typically run to handle load within the data processing system 10. All running CAP servers 40 may communicate with the same authentication backend (or replicated backends) 110. Typically, the exemplary embodiment is not responsible for replication, fail over, or synchronization of the authentication backend 110.

5. Secure Channel from the Client APIs. The communication between the client APIs 220 and 230 and the CAP server 40 is secured. This is necessary to prevent the “theft” of non-expiring authentication tokens 290. Security is provided by encapsulation at the transport layer so that alternate security methods may be used or “plugged in”. SSL is supported with optional RSA (Rivest Shamir Adleman encryption).

6. Encryption of Authentication Tokens. The authentication token 290 is encrypted to allow client applications 20 to verify that the authentication token 290 originated from the CAP server 40. This encryption makes its difficult for a bogus client application 20 to generate a valid authentication token 290.

7. Secure Channel to the Authentication Backends. Communications between the CAP server 40 and the authentication backend 110 is typicallly secured. The nature of the security will depend on what the particular backend 110 supports.

8. Support for Different Authentication Backends. The CAP server 40 has an authentication interface 240 for authentication backends 110. Different implementations of this authentication interface 240 may be plugged in. This architecture 200 supports and takes advantage of existing enterprise user/group authentication backends 110. The authentication backends 110 that may be supported include: NTLM (Available only if CAP is installed on NT), LDAP, ADS (as an LDAP interface), NDS (has an LDAP interface), and NIS. The authentication interface 240 typically has different drivers to talk to different authentication backends 110. These drivers typically implement secure connections with the authentication backends 110 depending on what the authentication backend supports.

9. Determination of Authentication Type. The CAP server 40 is interrogated by an application 20 to find out what authentication backend 110 choices are available. This allows applications 20 to display an appropriate dialog or otherwise obtain the needed credentials 300 from the user 30.

10. Authentication of Credentials. Once the client application 20 has obtained the credentials 300 from the user 30 it will then need to authenticate these against the CAP server 40. If a particular authentication backend 110 requires binary data, then that data is typically BASE64 encoded. For example, the data may be passed as a string. The CAP server 40 will authenticate the credentials 300 passed to it against the authentication backend 110 and will then produce an authentication token 300.

11. Validation of Authentication Tokens. The CAP server 40 provides employs encryption to verify that an authentication token 300 originated from the CAP server 40. This verification implies that the user 30 provided valid credentials 300. Once the authentication token 290 is verified, then the CAP server 40 will return the user ID (or user group ID) 310 associated with the authentication token 290.

12. Unified Representation of User Names and Group Names. Since an encapsulation layer for different authentication backends 110 is provided, the string representation of user names and group names may be unified. For example, in Windows NT (i.e. NTLM 270), a “USERNAME” and a “DOMAIN” name are typically used to uniquely identify a user 30. But, in a particular LDAP 280 directory, the “UID” attribute (e.g. “ron”) alone is typically used to uniquely identify a user 30. To prevent applications 20 from having to handle such differences using special logic code, the APIs 220, 230, and 240 typically present a unique, single string representation of a user ID (or user group ID) 310. For example, if the credentials 300 for an NT 270 login had a “USERNAME” of “ron” and a “DOMAIN” name of “fit”, then the user ID (or user group ID) 310 may be represented as “ron@fit” under the exemplary embodiment.

13. Support for the Anonymous User. The exemplary embodiment supports the concept of an anonymous user so that an authentication token 290 can be generated and passed to applications 20 identifying the user 30 as the anonymous user 30.

14. Retrieval of User Information. The APIs 220, 230, and 240 typically retrieve a list of all the single string representations of user IDs (or user group IDs) 310 from the authentication backends 110. The APIs 220, 230, and 240 typically check that a given single string representation of a user ID (or user group ID) 310 exists in an authentication backend 110.

15. Retrieval of Group Information. The invention provides APIs 220, 230, and 240 to retrieve a list of all the single string representations of user group IDs 310 from the authentication backends 110. APIs 220, 230, and 240 are also provided to list all the members of a group 310.

16. Use of Windows Login. Consider the situation where a user 30 is logged into Windows and the CAP server 40 has been configured to use NTLM 270 as the authentication backend 110. In such a case, the CAP server 40 is typically configured so that the user 30 does not have to login a second time. For example, some standalone products may have applications that run on the client machine and others may have HTML based front-ends. For the HTML case, IE and IIS (Internet information server) may be employed IIS is then typically configured to allow for NT “Challenge/Response” operation, which IE supports, and will present IIS with the currently logged in user without prompting for a username or password.

17. Read Only Authentication Backends. The native tools that exist for authentication backends 110 for creating users or groups, deleting users or groups, or changing passwords are typically used to perform the various user/group management functions.

18. Open Server. The CAP server 40 is an open server. This means that any client application 20 can call into the CAP server 40 without being authenticated for APIs 220, 230, and 240 like authentication, listing users, listing groups, and listing the members of groups.

19. Single Backend. The CAP server 40 typically supports a single authentication backend 110 at a time.

20. Unified Common View. The exemplary embodiment provides users 30 with a single, secure, unified, common view of many heterogenous authentication backend 110 directories to take advantage of any and all of the authentication backend 110 directories supported by the CAP server 40. The exemplary embodiment eliminates the need to write specific code for each authentication backend 110 directory service to interface with one another and hence eliminates the need for data processing systems (i.e. network environments) 10 to be restricted to one particular type of authentication backend 110 directory service. The CAP server 40 element of the exemplary embodiment provides a secure, single, unified, common view that consolidates local Windows NT, Windows NT Domains, LDAP, NIS, Active Directory, NDS or native UNIX accounts 110. Through the CAP server 40, users 30 only have to logon once, avoiding authentication to multiple applications 20 and servers. The exemplary embodiment provides a complete solution, addressing the need to reduce user logon complexity at the desktop while offering an open architecture to integrate easily into current enterprise environments or data processing systems 10, without changing existing authentication and access control infrastructures or authentication backends 110. The CAP server's 40 extensible architecture 200 provides a strong platform for both current and future requirements. The exemplary embodiment provides a unified view to many heterogeneous authentication backend 110 directories by proxying user authentication requests to a specified authentication backend 110 system. The exemplary embodiment secures logon authentication requests between the CAP server 40 and user applications 20 with SSL encryption. The exemplary embodiment provides encryption for both user credentials 300 and authentication tokens 290. Thus, two layers of encryption protection are provided.

Although the invention has been described with reference to certain specific embodiments, various modifications thereof will be apparent to those skilled in the art without departing from the spirit and scope of the invention as outlined in the claims appended hereto.

The embodiment of the invention in which an exclusive property or priviledge is claimed are defined as follows:

1. A method for implementing a common user logon to one or more applications said method comprising the steps of:
a) requesting credentials from said user for authenticating said user;
b) providing a common authentication server for issuing authentication tokens for identifying authenticated users; and
c) passing said authentication token to each application that said user requests access for authenticating said user to said accessed application without requesting re-entry of credentials from said user.
